(19) United States
(12) Patent Application Publication
(10) Pub. No.: US 2024/0400845 A1
(43) Pub. Date: Dec. 5, 2024

(54) OPAQUE INK COMPOSITION

(71) Applicant: Sanford, L.P., Atlanta, GA (US)

(72) Inventor: Vincent Kwan, Alpharetta, GA (US)

(73) Assignee: Sanford, L.P., Atlanta, GA (US)

(21) Appl. No.: 18/439,139

(22) Filed: Feb. 12, 2024

Related U.S. Application Data
(60) Provisional application No. 63/444,625, filed on Feb. 10, 2023.

(51) Int. Cl. C09D 11/17; C09D 11/20

(52) U.S. Cl. CPC C09D 11/17; C09D 11/20

(57) ABSTRACT

Compositions for use in writing instruments that provide for an opaque and permanent application and include a unique combination of a hollow particle component, a colorant, a viscosity modifier, a humectant, and an optional dispersant that result in shear-thinning properties.

### CROSS-REFERENCE TO RELATED APPLICATION

This application claims the benefit of U.S. Provisional Patent Application No. 63/444,625, filed Feb. 10, 2023, titled OPAQUE INK COMPOSITION, the entire contents of which are incorporated herein by reference.

### FIELD OF THE INVENTION

The present disclosure relates generally to compositions for use in writing instruments that provide for an opaque and permanent application. More particularly, the present disclosure provides compositions that include a unique combination of a hollow particle component, a colorant, a viscosity modifier, a humectant, and an optional dispersant. The composition has a high surface tension such that there is reduced penetration into porous substrates. Moreover, the composition possesses shear-thinning behavior such that the composition has a first structure and first viscosity in a non-shear state and a second structure and second viscosity in a shear state. Indeed, the composition of the present disclosure possesses a structure that is reversibly broken down as stress is applied and then removed. The present disclosure is also directed to a writing instrument containing the above composition.

### BACKGROUND OF THE INVENTION

Numerous efforts have been directed to opaque writing systems. However, such systems are not completely opaque and/or take a significant time to reveal. In fact, since traditional opaque pigments are very small in size, the pigment particles typically sink into the porous substrates, and the resulting opacity is compromised. In addition, water-based formulations with increased opacity generally lack ink permanence. Thus, it would be desirable to provide a highly opaque ink formulation that can be retained on a substrate surface to provide opacity. U.S. Patent Publication No. 2020/0255680 sought to solve the opacity and permanence issues with an ink formulation containing a solvent, a polymer-based hollow particle component, a resin, a coloring agent, and a humectant. The Newtonian ink formulation, designed for use in a conventional filter reservoir-nib writing instrument system, i.e., a marker, has a low viscosity, e.g., less than about 50 cP, so that the ink is able to flow through the reservoir and fibers in the nib. In addition, the resin in the ink formulation is used to impart permanence and adhesion onto substrates.

Moreover, conventional opaque ink compositions can include a white pigment for increasing the opacity of the ink composition. Traditionally, titanium dioxide can be used as the white pigment. However, titanium dioxide can be expensive. Furthermore, too much white pigment can result in an undesired pastel or muted color of the ink composition.

Thus, despite advancements in the opacity and permanence aspects, there is still a need for an improved opaque composition that possesses shear-thinning behavior, is appliable via a ballpoint tip, resides mainly on the substrate surface, looks the same regardless of the color and porosity of the underlying substrates, and is permanent in nature. In this aspect, it would be advantageous to have ink compositions that produce high-quality opaque markings on a variety of substrates after application via a ballpoint tip. Moreover, an ink composition that has a reduced time delay in opacity development would be beneficial.

Furthermore, it would be beneficial to have an ink composition that can achieve a desired opacity with less white pigment as compared to traditional ink systems.

Accordingly, the present disclosure provides compositions for use in writing instruments and writing instruments containing such compositions that allow for solid and lasting application.

### SUMMARY OF THE INVENTION

The problems expounded above, as well as others, are addressed by the following inventions, although it is to be understood that not every embodiment of the inventions described herein will address each of the problems described above.

The present disclosure provides compositions that impart opaque marks to an intended substrate. The compositions include at least one hollow particle component, a coloring agent, a viscosity modifier, a humectant, and an optional dispersant. The ink possesses a relatively high surface tension that helps to reduce penetration into porous substrates. The compositions may be substantially opaque.

Another embodiment of the present disclosure provides writing instruments that include and are capable of applying the compositions to a substrate. In some embodiments, the composition is contained in an ink storage compartment of the writing utensil. The writing utensil is selected from the group consisting of a ballpoint pen, a rollerball pen, and a gel pen.

The present disclosure further relates to a permanent ink composition including: a hollow particle component; a first colorant; a viscosity modifier; a humectant; and a solvent. In some embodiments, the composition also includes a dispersant present in an amount of about 2 to about 20 weight percent based on a total weight of the composition. In other embodiments, the viscosity modifier is present in an amount of about 1 to about 10 weight percent based on the total weight of the composition.

In some aspects, the hollow particle component is a polymeric hollow particle. The hollow particle comprises an outer layer or shell that contains an aqueous solution. In some embodiments, the ink composition archives substantial opacity when the aqueous solution has evaporated from the hollow particle, leaving behind the shell, which is designed to reflect light.

In some embodiments, the compositions disclosed herein include more than one colorant. Thus, the composition can include a first colorant and a second colorant. The first colorant and the second colorant may be different colors. Each of the first colorant and the second colorant can individually be selected from a pigment and a dye.

### BRIEF DESCRIPTION OF THE DRAWINGS

Further features and advantages of the invention can be ascertained from the following detailed description that is provided in connection with the drawings described below:

FIG. 1 is a writing instrument in accordance with an embodiment of the present disclosure;

FIG. 2 is a partial exploded view of the writing instrument of FIG. 1; and

FIG. 3 is a schematic illustrating various internal components of the writing instrument of FIGS. 1 and 2.

FIG. 4 is a comparative example of invention ink against comparative ink when written on black paper.

### DETAILED DESCRIPTION OF THE INVENTION

The present disclosure relates to compositions that may be used to produce inks that are substantially opaque. More specifically, the present disclosure relates to compositions that include an hollow particle component, a colorant, a viscosity modifier, a humectant, and an optional dispersant. The compositions may be used to fill a writing instrument, and the applied marking is substantially opaque regardless of the underlying substrate.

### Definitions

For the purposes of this disclosure, the following terms are defined as:

“Opacity” means the amount of visible light a coating of ink allows to pass through. Thus, “partial opacity” means that the ink does not completely obstruct the transmission of radiant energy therethrough. “Substantial opacity” means that the pigment (or composition including the pigment) is substantially impenetrable to visible light when applied to a substrate.

“Pigment” means finely ground particles of color that get suspended in a dispersing agent or vehicle. In particular, pigments are colored, usually inorganic compounds that are completely or nearly insoluble in water. Further, the pigment can be applied to the surface of a substrate so the pigment can physically bind with the substrate.

“Dye” means chemicals that are dissolved in water or other liquid medium to create a colorant. In particular, dyes can be organic, soluble compounds. Further, the dye can physically or chemically bind with a substrate to become part of the substrate.

### Composition

The compositions of the present disclosure include a hollow particle component, at least one colorant, a viscosity modifier, a humectant, and an optional dispersant. Details regarding each component and the resulting composition are provided below.

### Hollow Particle Component

The hollow particle component can be a polymeric hollow particle. The hollow particle can include a shell or outer layer comprised of a polymer and an inner liquid. In some embodiments, the inner liquid can be an aqueous solution. In other embodiments, the inner liquid can be an opacifying pigment.

The hollow particle component can provide at least partial opacity when filled with the inner liquid and/or in the absence of the inner liquid. For example, in some embodiments, the hollow particle component achieves substantial opacity when the inner liquid has evaporated, thereby leaving the outer layer of the hollow particle component behind. The outer layer can scatter and reflect light to achieve opacity.

As discussed above, traditional ink compositions can use white pigment to achieve opacity. However, due to the reflective nature of the outer layer of the hollow particle component, less pigment may be needed to achieve a desired level of opacity in the ink composition. Accordingly, an ink composition including the hollow particle component can achieve the same or greater opacity as compared to traditional ink compositions but with less white pigment. This can reduce the overall cost of the ink composition. Furthermore, it can be easier to achieve the desired color of the ink composition because there can be less white pigment that may dull or alter the color of one or more colorants included in the ink composition. Accordingly, brighter, truer colors can be achieved.

The hollow particle component can be provided in the form of an organic compound. Thus, the hollow particle component can also be more likely to reside on porous substrates when compared to their inorganic counterparts. In other words, the hollow particle component has a high hold out, i.e., does not penetrate into the substrate. Without being bound by any particular theory, the hollow particle component's surface energy/tension, particle size and narrow particle size distribution, and capability to coalesce may provide the high holdout, particularly when combined with the other ink composition components discussed herein, such as the solvent (e.g., water) and the humectant. Hold out may be indicated by the surface energy/tension of the hollow particle component and resulting ink composition. The hollow particle component, in turn, confers these benefits to the ink composition when used in the embodiments of the ink composition disclosed herein. In some embodiments, the hollow particle component has a surface tension of at least about 20 mN/m (millinewtons per meter). In other embodiments, the surface tension of the hollow particle component is about 20 mN/m to about 65 mN/m. In still other embodiments, the hollow particle component has a surface tension of about 45 mN/m to about 60 mN/m.

The hollow particle component may have a mean particle size of at least about 0.1 microns. In one embodiment, the mean particle size of the hollow particle component is about 1 micron or more. In another embodiment, the mean particle size is about 3 microns or more. For example, the hollow particle component may have a mean particle size that ranges from about 0.15 microns to about 20 microns. In some embodiments, the mean particle size of the hollow particle component is about 0.4 microns to about 15 microns. In other embodiments, the hollow particle component has a mean particle size of about 1 micron to about 10 microns.

Suitable commercially available hollow particle components include, but are not limited to, the Ropaque™ series from Dow Chemicals (Michigan, U.S.) (e.g., Ropaque™ Ultra, Ropaque™ Ultra EF, Ropaque™M OP-96, Ropaque™ Dual, and the like), Joncryl® 633 from BASF (Germany), Celecor® and Celecor® AF from Arkema (Germany), E-cryl® from Emulsion Systems (Florida, US), the Acusol® series from Dow (e.g., Acusolx OP301, Acusol® OP302B, Acusol® OP303, and Acusol® OP305), Orgal™ OPAC-101 from Organikkimya (Turkey), WoodPlus™ PS Opaque from Woodplus (U.S.), Hique 821 from Huku Lattice, and combinations thereof. In some embodiments, the hollow particle component is a hybrid hollow particle component, i.e., a mixture of inorganic pigments and organic polymers. Non-limiting examples include pigments from Heubach Gmbh (Germany), and the “TA” and “TR” series from Chuzhou Grea Minerals (China).

The hollow particle component may be present in the composition in an amount of at least about 5 percent by weight based on the total weight of the composition. In some embodiments, the hollow particle component is present in the composition in an amount of about 10 percent or more (based on the total weight of the composition). In other embodiments, the hollow particle component is present in the composition in an amount of about 15 percent or more (based on the total weight of the composition). In still other embodiments, the hollow particle component is present in the composition in an amount of about 15 percent to about 55 percent by weight based on the total weight of the composition. In one example, the composition includes about 25 percent to about 90 percent of the hollow particle component based on the total weight of the composition. In another example, the hollow particle component is present in an amount of about 20 to about 40 weight percent based on the total weight of the composition. In this aspect, the composition may include about 25 to about 35 weight percent of the hollow particle component (based on the total weight of the composition).

### Solvent

In some embodiments, the hollow particle component provides some level of opacity in the presence of one or more solvents. In this aspect, the hollow particle component may provide at least about 50 percent opacity in the presence of a solvent. In some embodiments, the hollow particle component provides at least about 60 percent opacity in the presence of a solvent. In other embodiments, the hollow particle component provides at least about 70 percent opacity in the presence of a solvent. Opacity may be measured using a reflective or transmission densitometer.

In some embodiments, the hollow particle component achieves substantial opacity when deprived of the solvent.

In some embodiments, substantial opacity can mean that at least about 90 percent of the light rays are prevented/obstructed from passing through by the hollow particle component. In other embodiments, substantial opacity means that at least 95 percent of light rays are prevented from passing through the coating of ink. In still other embodiments, substantial opacity means that at least 98 percent of light rays are prevented from passing through the coating of ink. In yet other embodiments, substantial opacity means that at least about 99 percent of light rays are prevented from passing through the ink coating. In other embodiments, the hollow particle component achieves full opacity in the absence of solvents. In this aspect, the hollow particle component can prevent about 100 percent of light rays from passing through the coating of ink.

Suitable solvents for use in the composition of the present disclosure include solvents that are capable of dissolving and/or suspending the components discussed herein. In addition, suitable solvents can confer high surface tension to the composition to reduce interfacial penetration.

The compositions may include a single solvent or a mixture of solvents. And, while surface tension ranges are discussed in more detail below, in some embodiments, the solvent is selected such that the composition has a surface tension of about 20 mN/m or more. In one embodiment, the solvent is selected such that the composition has a surface tension of about 25 mN/m or more. In some embodiments, the solvent has a surface tension of about 40 mN/m or more at room temperature. In other embodiments, the surface tension of the solvent is about 40 mN/m to about 75 mN/m. For example, the surface tension of the solvent may be about 45 mN/m to about 75 mN/m.

Non-limiting examples of suitable solvents for use in the compositions of the present disclosure include water, glycols (such as glycerol, propylene glycol, polyalkylene glycols, and diols), glycol ethers, poly (glycol) ethers, caprolactams, formamides, acetamides, and long chain alcohols. In some embodiments, the solvent may include primary aliphatic alcohols of 30 carbons or less, primary aromatic alcohols of 30 carbons or less, secondary aliphatic alcohols of 30 carbons or less, secondary aromatic alcohols of 30 carbons or less, 1,2-alcohols of 30 carbons or less, 1,3-alcohols of 30 carbons or less, omega.-alcohols of 30 carbons or less, ethylene glycol alkyl ethers, propylene glycol alkyl ethers, poly (ethylene glycol) alkyl ethers, higher homologs of poly (ethylene glycol) alkyl ethers, poly (propylene glycol) alkyl ethers, higher homologs of poly (propylene glycol) alkyl ethers, N-alkyl caprolactams, unsubstituted caprolactams, substituted formamides, unsubstituted formamides, substituted acetamides, unsubstituted acetamides, and combinations thereof.

In this aspect, suitable solvents include protic polar and aprotic polar solvents. Suitable protic polar solvents include, but are not limited to, water, glycerol, propylene glycol, diethylene glycol, ethers such as dipropyleneglycol monoether, and combinations thereof. Suitable aprotic polar solvents include, but are not limited to, dimethylsulfoxide, dimethylacetamide, dimethylforamide, formamide, N-methyl pyrrolidinone, N-Methyl morpholine, propylene carbonate, ethylene carbonate, and combinations thereof. In some embodiments, low-odor solvents such as water, glycol, and combinations thereof may be used.

When the composition includes a solvent system with more than one solvent, the first solvent may be any of the solvents listed above and the second solvent (or co-solvent) may include, but is not limited to, N-methyl pyrrolidone, 1,5-pentanediol, 2-pyrrolidone, diethylene glycol, triethylene glycol, tetraethylene glycol, 1,3-(2-methyl)-propanediol, 1,3,5-(2-methyl)-pentanetriol, tetramethylene sulfone, 3-methoxy-3-methylbutanol, glycerol, 1,2-alkyldiols, and combinations thereof.

The solvent(s) concentration may range from about 10 to about 60 weight percent based on the total weight of the composition. In one embodiment, the composition includes about 15 to about 55 weight percent of solvent based on the total weight of the composition. In this aspect, the total amount of solvent (with or without co-solvent) may be about 20 to about 50 percent by weight of the composition. For example, the total amount of solvent (with or without co-solvent) may range from about 25 to about 45 percent by weight of the composition. In one embodiment, the composition may include about 30 to about 40 weight percent solvent(s) by total weight of the composition.

### Colorant

The compositions of the present disclosure includes one or more colorants designed to display a color or facilitates the display of other colors when it is used in conjunction with the hollow particle component. Without being bound by any particular theory, the use of the hollow particle component with the colorant can reduce the time delay in the opacity development of the ink composition.

In some embodiments, the colorant for use in the compositions of the present disclosure is white in color. In this aspect, a suitable first colorant includes but is not limited to, titanium dioxide, zinc oxide, calcium carbonate, zinc sulfide, lithopone, alumina hydrate, calcium carbonate, blanc fixe, barytes, talc, silica, China clay, and combinations thereof.

In some embodiments, the colorant is not white. The non-white colorants can be provided in the form of inorganic pigments. In other embodiments, the non-white colorants are provided in the form of organic pigments. Organic pigments may also be suitable first colorants in accordance with the present disclosure, providing they possess suitable particle size and appropriate crystal lattice structure. Specifically, a suitable crystal lattice structure provides atom layers separated at a distance that maximize or provide a high degree of internal reflection of light. In some embodiments, the non-white colorants are pigments. The pigment may be added as a dry pigment and dispersed in a designated solvent matrix.

In this aspect, suitable blue pigments include, but are not limited to, Palomar® Blue B-4810PB 15:3, Palomar® Blue B-4710 PB 15:1, and Palomar® Blue B-4900 pigments from Bayer Corp. (Rock Hill, S.C.); and Sunfast™ Blue 15:3 presscake and Sunfast™ Blue 15:3 powder from Sun Chemical Corp. (Cincinnati, Ohio).

Suitable red pigments include, but are not limited to, magenta pigments like Quindo® Magenta RV-6828 Pigment Red 122, Quindo® Magenta RV-6831 Pigment Red 122 presscake, Quindo® Red R-6713 PV 19, and Quindo® Magenta RV-6843 Pigment Red 202 pigments from Bayer Corp.; and Sunfast™ Magenta 122 and Sunfast™ Magenta 202 pigments from Sun Chemical Corp.

Suitable yellow pigments include, but are not limited to, Fanchon® Fast Y-5700 PY 139and Fanchon® Fast Yellow Y-5688 C.I. Pigment Yellow 150 pigments from Bayer Corp.; Sunbrite® Yellow 14 presscake and Spectra Pac Yellow 83 pigments from Sun Chemical Corp.; Sandorin™ Yellow 6GL (from Clariant Corp. of Charlotte, N.C.); and Irgazin® Yellow 2RLT PY 110, Irgazin® Yellow 2GLTN PY 109, Irgazin® Yellow 2GLTE PY 109, and Irgazin® Yellow 3RLTN PY 110 pigments from Ciba Geigy.

Suitable green pigments include, but are not limited to, copper phthalocyanine green pigment like Pigment Green 1, Pigment Green 2, Pigment Green 7, and Pigment Green 36, and mixtures thereof.

Violet colorants include, but are not limited to, quinacridone, benzimidazolone, and mixtures thereof. Violet colorants include, but are not limited to, Pigment Violet 19, Pigment Violet 3, Pigment Violet 32, and Pigment Violet 23, and mixtures thereof.

Orange colorants include, but are not limited to, a β-naphthol pigment, a Naphthol Reds pigment, or combinations thereof, as well as Pigment Orange 5, Pigment Red 17, Pigment Red 188, Pigment Orange 62, Pigment Red 112, Pigment Red 255, Pigment Red 264, and Pigment Red 49:2, and mixtures thereof.

Suitable black pigments include, but are not limited to, carbon black, e.g., Special Black 4,Special Black 5, Special Black 6, Special Black 4A, Color Black FW 200, and Color Black FW2pigments (from Degussa Corporation of Ridgefield, N.J.); Raven 1200 carbon black, Raven 1170carbon black, Raven 3500 carbon black, and Raven 5750 carbon black pigments (from Columbian Chemical Corp. of Atlanta, Ga.); Mogul L carbon black and Sterling NS carbon black pigments (from Cabot Corp. of Boston, Mass.); and Carbon Black MA-100 pigment (from Mitsubishi Kasei Corp. of Tokyo, Japan).

If the colorant is a pigment, the average particle size (mean diameter) of the colorant is about 0.5 micron or greater. In some embodiments, the particle size is about 2 microns or more. In other embodiments, the average particle size is about 4 microns or more. Without being bound by any particular theory, this range of particle sizes can prevent the colorant from being muted in color because the colorant may not be absorbed in the pores of the substrate. In some aspects, the average particle size of the colorant is about 0.5 micron to about 200 microns. In other aspects, the average particle size of the colorant is about 5 microns to about 200 microns. For example, the average particle size of the colorant may range from about 5 microns to about 50 microns. By way of further example, the average particle size of the colorant may be about 25 microns to about 150 microns. In other aspects, the average particle size of the colorant is about 50 microns to about 1000 microns. For example, the average particle size of the colorant may be about 250 microns to about 750 microns.

If the colorant is a pigment, the pigment can be first dispersed in an appropriate solvent to become a pigment dispersion prior to addition into the composition. Examples of such dispersions include, but are not limited to, Tint-Ayd water-based dispersion line from Elementis, Levanyl® series from Lanxess (Germany), Hostafine line from Heubech-Clariant (Germany), Neotint series from Milliken (Spartanburg, SC), water-based pigment dispersion from Chromatech (Canton, MI), Chromachem 896 from Chromaflo (Ashtabula, Ohio), and combinations thereof. In other embodiments, the pigment can be in a preparation that can be easily dispersed upon contact with the appropriate solvent. Examples of such preparations include, but are not limited to, the xFast and Microlith lines from BASF (Germany) and the Agrocer line from Clariant (Germany).

Suitable colorants can also include dyes capable of adhering to the surface of the opacifying particles and provide color even when written on dark color porous substrates. Examples of such dyes include, but are not limited to, Victoria Blue, Basic Red 14, Basic Yellow 49, Basic Red 15, and combinations thereof. In some embodiments, the dyes are in a liquid form, e.g., Fisco® Pink 664 and Fisco® Blue (from Orient, U.S.), and Intrabondx Pink BR200 (from Sensient of St. Louis, US).

As would be appreciated by those of ordinary skill in the art, the concentration of the colorant should be application and desired color dependent. However, generally, the composition includes a colorant in an amount of about 5 percent to about 30 percent by weight based on the total weight of the composition. In one embodiment, the colorant is included in the composition in an amount within a range having a lower limit of about 5 percent or about 7 percent or, about 9percent, about 11 percent, 13 percent or about 15 percent, and an upper limit of about 20 percent or about 22 percent or about 24 percent or about 26 percent or about 28 percent or about 30 percent. For example, the colorant may be present in the composition in an amount of about 5 percent to about 25 percent by weight based on the total weight of the composition. In another example, the composition includes about 7 percent to about 20 percent of the colorant based on the total weight of the composition. In still another example, the colorant is present in the composition in an amount of about 8 percent to about 15 percent by weight based on the total weight of the composition.

Further, the compositions of the present disclosure can include one or more additional colorants to enhance or alter the color of the ink composition. Thus, in embodiments comprising more than one colorant, one colorant can be referred to as a first colorant and the other colorant(s) can be referred to a second, a third, a fourth, etc., colorant. The additional colorant can be provided in the same form as the first colorant. However, the additional colorant can be a different color from the first colorant.

When included, the composition may include the additional colorant(s) in an amount of about 0.5 percent to about 20 percent by weight based on the total weight of the composition. In one embodiment, the additional colorant(s) is included in the composition in an amount within a range having a lower limit of about 1 percent, about 2 percent, about 3 percent, about 4 percent, or about 5 percent, and an upper limit of about 8 percent or about 10 percent or about 12 percent or about 14 percent or about 16 percent or about 18 percent or about 20 percent. For example, the additional colorant(s) may be present in the composition in an amount of about 2 percent to about 20 percent by weight based on the total weight of the composition. In another example, the composition includes about 4 percent to about 18 percent additional colorant(s) based on the total weight of the composition. In still another example, the additional colorant(s) is present in the composition in an amount of about 5 percent to about 15 percent by weight based on the total weight of the composition.

### Viscosity Modifier

The compositions of the present disclosure can include a viscosity modifier such as a thickening agent. Without being bound by any particular theory, the viscosity modifier confers shear-thinning properties to the ink composition, which, in turn, provides the ink composition with a higher viscosity before the ink is applied to a substrate than after. In other words, as a result of the thickening agent, the hydrogen bonding network in the composition may be broken down as shear is applied, i.e., when a ball in the tip of a ballpoint writing utensil begins to rotate, the thermal bonds break, which reduces the viscosity of the composition. When the ball stops rotating, the hydrogen bonding network rebuilds itself, and the viscosity of the composition returns to its previous non-shear value in order to prevent leakage of the composition from the writing instrument. The shear-thinning properties conferred on the ink composition also contribute to the ability of the composition to be held on the substrate surface, imparting maximum opacity.

Viscosity modifiers suitable for use in the compositions of the present disclosure include those materials appropriate for topical administration, compatible with the other components in the composition, and possess composition thickening properties. In this aspect, silica, clays, and combinations thereof may be used as viscosity modifiers in the compositions. However, without being bound to any particular theory, it is believed that particular viscosity modifiers may allow minimal settling. In this regard, in some embodiments, the viscosity modifier may be a solid emollient material that has a melting point of at least about 40° C. Non-limiting examples of suitable solid emollient materials useful in the compositions of the present disclosure include C₁₄-C₄₀ fatty alcohols, polyethylenes, alkyl (C₁₈-C₄₅) methylsiloxanes, jojoba ester waxes, hydrogenated vegetable oils, and mixtures thereof.

For instance, viscosity modifiers for use in the compositions of the present disclosure may be selected from high melting point and/or low melting point waxes and mixtures of such waxes. Suitable high melting point waxes (66-101° C.) include, but are not limited to, beeswax, montan, ozokerite, ceresin, paraffin, hydrogenated castor oil, C₂₆-C₄₀ linear alcohols, and combinations thereof. Suitable low melting point waxes (40-65° C.) include, but are not limited to, C₁₄-C₂₅ fatty alcohols, fatty esters, fatty amides, particularly stearyl alcohol, cetyl alcohol, stearic acid, polydimethylsiloxanyl beeswax, and combinations thereof. In one embodiment, the thickening agent is a C₁₆-C₂₂ fatty acid and/or fatty alcohol.

In some embodiments, the viscosity modifier is a stearyl alcohol, hydrogenated castor oil, or a mixture thereof. In other embodiments, the viscosity modifier includes mineral oil, petrolatum, or mixtures thereof.

The viscosity modifier may be chosen from nonthixotropic hydrophilic viscosity modifiers when the composition includes an aqueous medium. In this aspect, suitable hydrophilic viscosity modifiers may include, but are not limited to, water-soluble cellulosic viscosity modifier s, guar gums, quaternized guar gums, nonionic guar gums including C₁-C₆ hydroxyalkyl groups, xanthan, carob, scleroglucan, gellan, rhamsan and karaya gums, alginates, maltodextrin, starch and derivatives thereof, hyaluronic acid and salts thereof, polyglyceryl (meth) acrylate polymers, polyvinylpyrrolidones, polyvinyl alcohols, crosslinked polymers and copolymers of acrylamide, associative polymers (such as associative polyurethanes), and mixtures thereof.

The viscosity modifier may be present in the composition in an amount of about 0.5 percent to about 25 weight percent based on the total weight of the composition. In some embodiments, the viscosity modifier is present in the composition in an amount of about 1 weight percent to about 15 weight percent or about 1 weight percent to about 10 weight percent based on the total weight of the composition. In other embodiments, the viscosity modifier is present in the composition of the present invention in an amount of about 2 weight percent to about 10 weight percent based on the total weight of the composition.

### Humectant

One of the challenges of using water in an ink composition intended for permanent application is the inability of the ink to resume fluidity after it is dried. In particular, when the writing instrument includes a retractable body, the point/tip of the writing instrument may remain exposed after/in between applications. Without being bound to any particular theory, including an appropriate humectant in the composition may help to avoid such issues. In some embodiments, a humectant for use with the composition of the present disclosure includes organic materials miscible with water.

In this aspect, suitable humectants include, but are not limited to, simple polyols, oligomeric and polymeric polyols such as polyethers or polyesters, and combinations thereof. Examples of such alcohols include, but are not limited to, polyethylene glycol, polypropylene glycol, poly (tetramethylene ether) glycol, and combinations thereof. In some embodiments, the humectant is polyethylene glycol. Commercially available alcohols for use as the humectant include those from the Pluracol P series from BASF (Germany) and Voranol P400 from Dow Chemicals (Michigan, U.S.).

A non-exhaustive list of other suitable humectants that can be used include ethylene glycol, propylene glycol, diethylene glycols, glycerine, dipropylene glycols, sorbitol, amides, urea, substituted ureas, ethers, carboxylic acids, esters, alcohols, organosulfides, organosulfoxides, sulfones (such as sulfolane), alcohol derivatives, carbitol, butyl carbitol, cellusolve, ether ketones, derivatives, amino alcohols, N-methylpyrrolidinone, 2-pyrrolidinone, cyclohexylpyrrolidone, hydroxyethers, amides, sulfoxides, lactones, and other water miscible materials, as well as mixtures thereof.

The humectant may be present in the composition of the present disclosure in any effective amount. In some embodiments, the water-to-organic ratio is from about 100:0 to about 30:70. In other embodiments, the water-to-organic ratio is from about 97:3 to about 50:50. In still other embodiments, the water-to-organic ratio is from about 90:10 to about 70:30.

The humectant concentration may range from about 5 to about 30 weight percent based on the total weight of the composition. In one embodiment, the composition includes about 10 to about 25 weight percent of humectant based on the total weight of the composition. In this aspect, the total amount of humectant may be about 10 to about 20 percent by weight of the composition.

For example, the total amount of humectant may range from about 12 to about 18 percent by weight of the composition.

### Additives and Fillers

Other additives may be added to the composition to further enhance the physical properties. In some embodiments, the compositions of the present invention include about 0.1 percent to about 5 percent by weight additive(s). In other embodiments, the compositions include about 0.5 percent to about 3 percent by weight additives. In this aspect, suitable additives include, but are not limited to, humectants, surfactants, biocides, antimicrobials, fungicides, rheological modifiers and processing aids, dispersants, defoamers, co-solvents, additional colorants, thermal stabilizers, scents, glitter, lubricants, plasticizers, preservatives, optical brighteners, antioxidants and combinations thereof.

For example, according to the present invention, one or more preservatives, such as antimicrobial agents and fungicides, may be added to increase the shelf life of the compositions. Nonlimiting examples of suitable preservatives include Fungitrol® 940, Kathon® LX, Nuosept® 95, Acticide® LA, and Polyphase® P100. Non-limiting examples of suitable processing aids include Hydropalat® 44. Lubricants or plasticizers, such as oleic acid, isobutyl stearate, polyoxyethylene alkali metal salt, dicarboxylic acid amide, phosphoric acid ester, and like, may be added to soften the compositions to improve the transfer of the colorant to the substrate. As the surfactant, for example, an anionic surfactant, a nonionic surfactant, or the like can be used.

Rheology modifiers may also be added to the compositions of the present disclosure to adjust the pseudoplastic flow state to make the compositions suitable for use in writing instruments. Non-limiting examples include alkali metal salts, amine salts, alkanolamine salts of cross-linked acrylic acid polymers, associative urethane resin viscosity modifiers, and combinations thereof. If used, the rheology modifier may be used in an amount of about 0.01percent to about 5 percent by weight based on the total weight of the composition. In one embodiment, the composition includes about 0.1 percent to about 5 percent by weight based on the total weight of the composition.

The composition may also include filler(s). Suitable non-limiting examples of fillers include glass (e.g., glass flake, milled glass, and microglass), mica, and combinations thereof. Metal oxide and metal sulfate fillers are also contemplated for inclusion in the composition.

Suitable metal fillers include, for example, particulate, powders, flakes, and fibers of copper, steel, brass, tungsten, titanium, aluminum, magnesium, molybdenum, cobalt, nickel, iron, lead, tin, zinc, barium, bismuth, bronze, silver, gold, and platinum, and alloys and combinations thereof. Suitable metal oxide fillers include, for example, zinc oxide, iron oxide, aluminum oxide, titanium oxide, magnesium oxide, and zirconium oxide. Suitable metal sulfate fillers include, for example, barium sulfate and strontium sulfate.

In some embodiments, the composition of the present disclosure includes colored fillers having a particle size of about 1 micron or more. For example, a suitable colored filler may have a particle size of about 2 microns to about 20 microns. In one embodiment, a suitable colored filler has a particle size of about 2 microns to about 10 microns. In another embodiment, a suitable colored filler has a particle size of about 2 microns to about 8 microns. When included, the fillers may be in an amount of about 1 to about 25 weight percent based on the total weight of the composition. In one embodiment, the composition includes at least one filler in an amount of about 5 to about 20 or about 8 to about 15 parts by weight per 100 parts of the total composition. In another embodiment, the composition includes at least one filler in an amount of about 8 to about 14 or about 10 to about 12 parts by weight per 100 parts of the total composition. In yet another embodiment, the composition includes at least one filler in an amount of about 10 to about 17 or about 12 to about 15 parts by weight per 100 parts of the total composition. In yet another embodiment, the composition includes at least one filler in an amount of about 10 to about 16 or about 12 to about 15 parts by weight per 100 parts of the total composition. In a further embodiment, the composition includes at least one filler in an amount of about 12 to about 18 or about 14 to about 16 parts by weight per 100 parts of the total composition.

In some embodiments, more than one type of additive and/or filler may be included in the composition. For example, the composition may include a first filler in an amount from about 5 to about 20 or about 8 to about 17 parts by weight per 100 parts total rubber and a second filler in an amount from about 1 to about 10 or about 3 to about 7 parts by weight per 100 parts total composition. In another example, the composition may include a first filler in an amount from about 7 to about 13 or about 9 to about 12 parts by weight per 100 parts total composition and a second filler in an amount from about 2 to about 8 or about 4 to about 6 parts by weight per 100 parts total composition. In yet another example, the composition may include a first filler in an amount from about 10 to about 15 or about 13 to about 14 parts by weight per 100 parts total composition and a second filler in an amount from about 2 to about 9 or about 3 to about 7 parts by weight per 100 parts total composition. In a further example, the composition may include a first filler in an amount from about 10 to about 15 or about 13 to about 14 parts by weight per 100 parts total composition and a second filler in an amount from about 13 to about 18 or about 14 to about 16 parts by weight per 100 parts total composition.

### Properties

The compositions of the present disclosure provide many advantages over conventional opaque ink compositions. In this regard, a composition of the present disclosure may be substantially opaque over a range of substrates, including semi-porous and porous substrates and colored and non-colored substrates. In addition, the permanence of the composition may also be accomplished over the range of substrates. For the purposes of this disclosure, the term “permanent” or “permanence” refers to the ability of the composition to adhere to a variety of substrates without being removed by simple abrasion. Indeed, unlike other ink compositions that purport to be opaque and permanent, once the composition of the present disclosure is applied, the marking/color is substantially opaque and cannot be removed by simple abrasion.

### Surface Tension

The compositions of the invention preferably have a surface tension sufficient to avoid penetration into the substrate. In this aspect, the surface tension of the composition may be about 20 mN/m or more. In some embodiments, the surface tension of the composition is about 25 mN/m or more. In other embodiments, the surface tension of the composition is about 40 mN/m or more. In still other embodiments, the surface tension of the composition is about 75 mN/m or less. In yet other embodiments, the surface tension of the composition is about 70 mN/m or less. For example, the composition may have a surface tension of about 25 mN/m to about 70 mN/m, about 40 mN/m to about 75 mN/m, 45 mN/m to about 65 mN/m, and any other ranges encompassed by the disclosure herein.

### Viscosity

The viscosity of the composition of the present disclosure decreases with increasing shear stress. In other words, the compositions of the present disclosure have a viscosity in a non-shear state, i.e., prior to application, that differs from the viscosity in a shear state, i.e., as the composition is being applied and the ball of the tip is rotating. In this aspect, the non-shear state viscosity is greater than the shear state viscosity. In some embodiments, the non-shear state viscosity is at least about 1000 times greater than the shear state viscosity.

### Reveal Time

The compositions of the present disclosure have a reveal time, i.e., the time duration between the first application (laydown) and the first visual indication of color on the substrate, of between about 0.1 seconds and about 15 seconds. In some embodiments, the reveal time of the composition is between about 0.1 seconds and about 10 seconds. In other embodiments, the reveal time of the composition is between about 0.25 seconds and about 5 seconds.

### Writing Instrument

Writing instruments of varying types, including, but not limited to, ballpoint, rollerball, and gel pens, may be filled with the compositions of the present disclosure. In some embodiments, the compositions of the present disclosure may be used in a writing instrument that includes an ink storage compartment and a tip attached to one end of the ink storage compartment for delivering the compositions of the present disclosure to a substrate. The ink storage compartment and the tip may be directly connected or connected through a connection member.

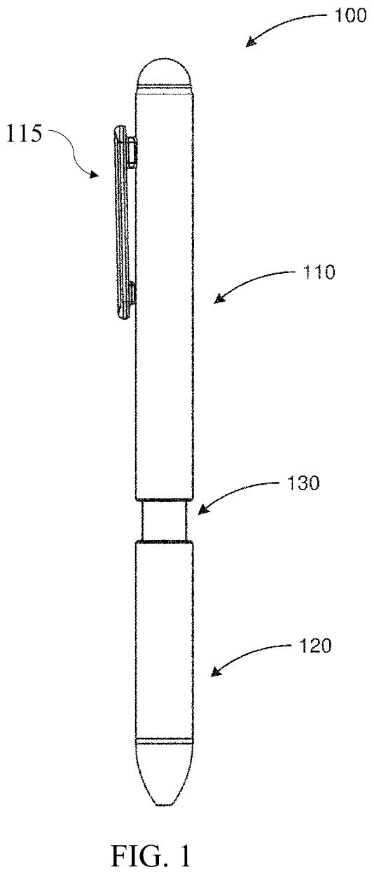

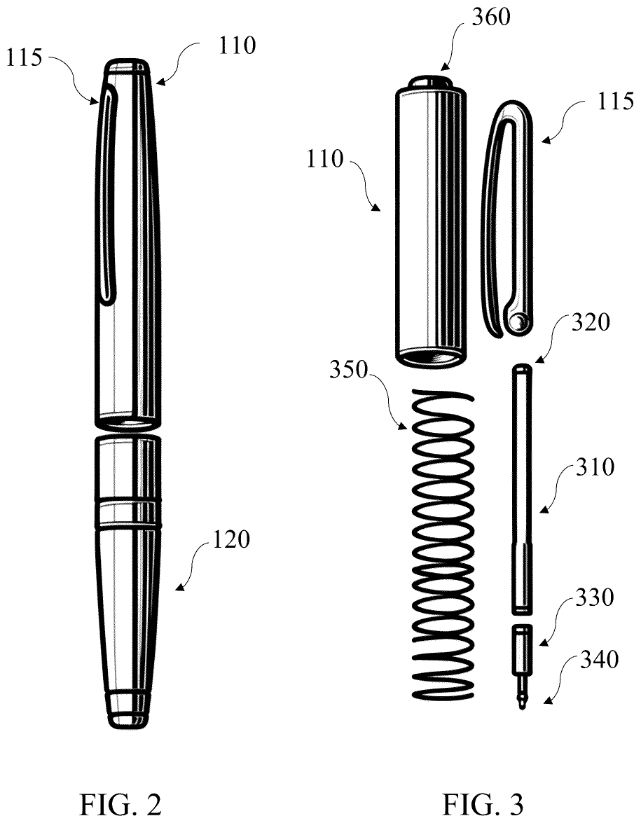

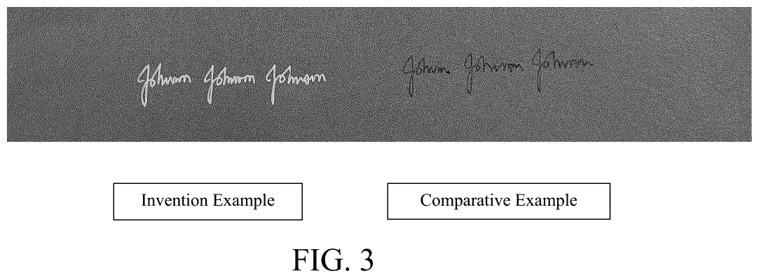

For example, a writing instrument 100, as shown in FIGS. 1 and 2, may include a body 110, a clip 115, a tip 120, and a connection member 130. The body 110 can also be referred to as a barrel. The body 110, the tip 120, and the connection member 130 can be axially aligned. As shown best in FIG. 3, the body 110 may include a storage compartment 310, such as a reservoir, that is filled with a composition of the present disclosure. The storage compartment 310 can be provided in the form of a hollow tube-like structure designed to form a well for holding the ink composition. A first end 320 of the storage compartment 310 can be sealed or closed (e.g., by means of a mechanical seal or a cap). A second end 330 of the storage compartment 310 can be connected to a nib 340 such that the composition held within the storage compartment 310 can be delivered to the nib 340. The nib 340 may extend from the tip 120. Thus, the nib 340 may be designed to deliver the composition to a writing surface. In one instance, the storage compartment 310 is removable. Thus, the storage compartment 310 can be designed to be replaceable.

In one embodiment, the nib 340 is retractable. Thus, in some aspects, the writing instrument 100 can further include a spring 350 and a plunger 360 designed to compress and/or decompress the nib 340. The spring 350 can be located within the body 110 and designed to at least partially encircle or wrap around a portion of the storage compartment 310. In some embodiments, the plunger 360 can be positioned on an opposite end of the writing instrument from the tip 120. In some embodiments, the writing instrument 100 can include a plurality of storage compartments (e.g., the storage compartment 310 of FIG. 3). The plurality of storage compartments can each be designed to hold a different ink composition (e.g., ink compositions including different colorants). Thus, in some aspects, the writing instrument can also include a plurality of nibs (e.g., the nib 340 of FIG. 3), a plurality of springs (e.g., the spring 350 of FIG. 3), and a plurality of plungers (e.g., the plunger 360 of FIG. 3). For example, each storage compartment can include or be connected to a tip, spring, and plunger. Accordingly, a user can select a particular ink composition (e.g., an ink color) by depressing the plunger for the storage compartment associated with the chosen ink, thereby causing the tip for the associated storage compartment to be revealed from the body 110.

In another embodiment, the tip is not retractable, but the writing instrument 100 includes a cap to prevent the tip from drying out. In some instances, the end of the writing instrument opposite from the tip can be designed such that the cap can fit over the end. Thus, the user can store the cap on the end while using the nib 340.

### EXAMPLES

The invention is further illustrated by the following examples. It should be understood that the examples below are for illustrative purposes only. These examples should not be construed as limiting the scope of the invention.

Compositions formed in accordance with the present disclosure are provided in the examples below. These examples provide the components included in each composition. Concentrations of each component are provided in parts by weight per 100 parts of the total composition unless stated otherwise.

### Inventive Examples 1-3: Compositions and Application Thereof

Three inventive examples (i.e., Ex. 1-3) and two comparative examples (i.e., Comp. Ex. A-B) were prepared according to Table 1 below. The components of the compositions in each example set forth in Table 1 were mixed until a homogenous mixture was achieved.

TABLE 1
Compositions

| | | | | | Comp. | Comp. |
|---|---|---|---|---|---|---|
| Component | | Ex. 1 | Ex. 2 | Ex. 3 | Ex. A | Ex. B |
| Solvent | Water | 33 | 33 | 38 | 25 | 33 |
| Hollow particle | Ropaque ® OP-96 | 30 | — | — | — | 30 |
| component | | | | | | |
| Hollow particle | Celerco ® AF | — | 30 | 30 | — | — |
| component | | | | | | |
| Non-opacifying | Rovene ® 6113 | — | — | — | 50 | — |
| Polymer | | | | | | |
| First pigment | Calcium carbonate | 10 | 10 | 10 | — | — |
| Red Colorant | Hostafine ® Red 3S | 10 | 10 | — | 10 | 10 |
| Dispersant | | | | | | |
| Blue Colorant | Victoria Blue | — | — | 5 | — | — |
| Viscosity modifier | Rheovis ® PU1191 | 2 | 2 | 2 | 2 | 2 |
| Non-Permanent | Celvol ® 523S | — | — | — | — | 10 |
| Resin | | | | | | |
| Humectant | Glycerine | 15 | 15 | 15 | 15 | 15 |
| | | 100 | 100 | 100 | 100 | 100 |

The homogeneous mixtures were added into refill compartments fitted to Sharpie® Gel pens. The homogeneous mixtures were applied to porous black paper and the line opacity was judged visually.

TABLE 2
Opacity and Reveal Time Results

| | | | | Comp. | Comp. |
|---|---|---|---|---|---|
| Testing Parameter | Ex. 1 | Ex. 2 | Ex. 3 | Ex. A | Ex. B |
| Opacity of Line on | 5 | 5 | 5 | 2 | 4 |
| Black Paper¹ | | | | | |
| Time to develop | <2 | <2 | <2 | >30 (Weak | >30 |
| color² | | | | color | |
| | | | | observed) | |

¹A score of 5 means bright, opaque line was observed, whereas a score of 1 means the line was almost invisible.
²Time to fully develop was measured in seconds using a stopwatch.

As shown in Table 2, the inventive examples (i.e., the compositions made in accordance with the present disclosure) exhibited a bright, opaque line in less than 2 seconds after application on a porous black substrate. In comparison, Comp. Exs. A-B lacked opacity. Indeed, the pigment in Comp. Ex. A penetrated into the paper resulting in a weak line even after 30 seconds. Comp. Ex. B exhibited a time delay of greater than 30 seconds in showing the color. In short, unlike the prior art, comparative ink formulations, compositions made in accordance with the present disclosure provide opaque and instant-reveal markings.

Inventive Examples 4-X: Compositions and Application Thereof

Three inventive examples (i.e., Ex. Ex. 1-3) and two comparative examples (i.e., Comp. Ex. A and B) were prepared according to Table 3 below.

| | | | | Comp. | Comp. |
|---|---|---|---|---|---|
| Component | Ex. 1 | Ex. 2 | Ex. 3 | Ex. A | Ex. B |
| Solvent | 10 | 10 | 5 | 25 | 33 |
| Hollow particle | 40 | — | 40 | — | 30 |
| component | | | | | |
| Hollow particle | — | 40 | — | — | — |
| component | | | | | |
| Non-opacifying Polymer | — | — | — | 48 | — |
| First pigment | 20 | 20 | 20 | — | — |
| Red Colorant | 10 | — | 5 | 10 | 10 |
| Blue Colorant | — | 10 | 5 | — | — |
| Viscosity modifier | 5 | 5 | 5 | 2 | 2 |
| Non-Permanent Resin | — | — | 5 | — | 10 |
| Humectant | 15 | 15 | 15 | 15 | 15 |
| Total | 100 | 100 | 100 | 100 | 100 |

Similar to Inventive Examples 1-3 and Comparative Examples A-B, the above compositions were mixed until a homogenous mixture was achieved. The homogeneous mixtures were added into refill compartments fitted to Sharpie® Gel pens. The homogeneous mixtures were applied to porous black paper and the line opacity was judged visually. FIG. 4 illustrates a visual example of an invention ink against a comparative ink when written on black paper.

As shown in FIG. 4, the inventive example (i.e., the compositions made in accordance with the present disclosure) exhibited a bright, opaque line after application on a porous black substrate. In comparison, the comparative example lacked opacity and was not as visible on the substrate. Thus, as can be seen, unlike the conventional ink formulations, compositions made in accordance with the present disclosure provide more opaque markings.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural forms as well (i.e., at least one of whatever the article modifies), unless the context clearly indicates otherwise.

The terms “first,” “second,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure. Likewise, terms like “top” and “bottom”; “front” and “back”; and “left” and “right” are used to distinguish certain features or elements from each other, but it is expressly contemplated that a top could be a bottom, and vice versa.

The compositions described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications in addition to those shown and described herein will become apparent to those skilled in the art from the foregoing description. Such modifications are also intended to fall within the scope of the appended claims. All patents and patent applications cited in the foregoing text are expressly incorporated herein by reference in their entirety. Any section headings herein are provided only for consistency with the suggestions of 37 C.F.R. § 1.77 or otherwise to provide organizational queues. These headings shall not limit or characterize the invention(s) set forth herein.

What is claimed is:

1. A composition, comprising:
a hollow particle component;
a first colorant;
a viscosity modifier;
a humectant; and
a solvent.

2. The composition of claim 1, wherein the first colorant is present in an amount of about 5 to about 15 weight percent based on a total weight of the composition.

3. The composition of claim 1, wherein the hollow particle component is present in an amount of about 20 to about 40 weight percent based on a total weight of the composition.

4. The composition of claim 1, wherein the humectant is present in an amount of about 10 to about 20 percent based on a total weight of the composition.

5. The composition of claim 1, wherein the viscosity modifier is present in an amount of about 1 to about 10 weight percent based on a total weight of the composition.

6. The composition of claim 1, further comprising a dispersant present in an amount of about 2 to about 20 weight percent based on a total weight of the composition.

7. The composition of claim 1, further comprising a second colorant having a different color from the first colorant.

8. The composition of claim 1, wherein the composition is included in an ink storage compartment of a writing utensil.

9. A permanent ink composition comprising:
a hollow particle component;
a first colorant;
a viscosity modifier;
a humectant;
a solvent; and
an optional dispersant, wherein the composition has a first viscosity at a non-shear state and a second viscosity at a shear state, and wherein the second viscosity is less than the first viscosity.

10. The permanent ink composition of claim 9, wherein the colorant is present in an amount of about 5 to about 15 weight percent based on a total weight of the composition.

11. The permanent ink composition of claim 9, wherein the hollow particle component is present in an amount of about 20 to about 40 weight percent based on a total weight of the composition.

12. The permanent ink composition of claim 9, wherein the humectant is present in an amount of about 10 to about 20 percent based on a total weight of the composition.

13. The permanent ink composition of claim 9, wherein the viscosity modifier is present in an amount of about 1 to about 5 weight percent based on a total weight of the composition.

14. The permanent ink composition of claim 9, comprising about 2 percent to about 20 weight percent dispersant based on a total weight of the composition.

15. The permanent ink composition of claim 9, further comprising a second colorant having a different color from the first colorant.

16. The permanent ink composition of claim 9, wherein the permanent ink composition is included in an ink storage compartment of a writing utensil.

17. An ink composition for use in a writing utensil, comprising:
a hollow particle component;
at least one colorant;
a viscosity modifier;
a humectant; and
a solvent,
wherein the ink composition is included in an ink storage compartment of the writing utensil.

18. The ink composition of claim 17, further comprising a dispersant present in an amount of about 2 to about 20 weight percent based on a total weight of the composition.

19. The ink composition of claim 17, wherein the viscosity modifier is present in an amount of about 1 to about 5 weight percent based on a total weight of the composition.

20. The ink composition of claim 17, wherein the at least one colorant includes a first colorant of a first color and a second colorant of a second color different than the first color.
